(19) United States
(12) Patent Application Publication
(10) Pub. No.: US 2014/0143124 A1
(43) Pub. Date: May 22, 2014

(54) Equity Crowd Funding With Heterogeneous Investors

(71) Applicant: BlazeFund, Inc., Boston, MA (US)

(72) Inventor: Aaron M. Sanders, Wellesley, MA (US)

(73) Assignee: BlazeFund, Inc., Boston, MA (US)

(21) Appl. No.: 14/165,660

(22) Filed: Jan. 28, 2014

Related U.S. Application Data
(63) Continuation of application No. 13/930,028, filed on Jun. 28, 2013.
(60) Provisional application No. 61/666,345, filed on Jun. 29, 2012.

(51) Int. Cl. G06Q 40/04

(52) U.S. Cl. CPC G06Q 40/04
USPC 705/37

(57) ABSTRACT

In some embodiments of the invention, a method operates an equity crowd funding system with different types of investors. The method includes registering a company with an equity crowd funding system. The method may also include registering a first investor with the equity crowd funding system. The method may also include registering a second investor with the equity crowd funding system. Each of the first and second investors is an unaccredited investor, an accredited investor, an institutional investor, a non-profit investor, or an entrepreneur. Further, the first and second investors are different types of investors. The method may also include sending offers for equity holdings in the company in exchange for funds to the first and second investors.

### RELATED APPLICATION

This application is a continuation application of U.S. application Ser. No. 13/930,028, entitled “Systems and Methods for Equity Crowd Funding,” and filed Jun. 28, 2013, which claims priority to U.S. Application No. 61/666,345, entitled “Crowd Funding Private Equity Investment Processing System and Method” and filed Jun. 29, 2012, both of which are incorporated herein, in their entireties, by reference.

### TECHNICAL FIELD

The invention pertains to the field of equity investments. More particularly, the invention pertains to systems and methods of crowd funding.

### BACKGROUND ART

Entrepreneurs will soon be able to raise capital online in the US up to $1M. There are some processes for equity based crowd funding mechanisms in use in the international market. Most such processes, however, are based on crowd investors reviewing a project summary or a company profile online with minimal financial details, and making commitments to fund manually, one decision at a time, in just a single round of funding.

The process of private equity investment in the venture capital industry includes the steps of an entrepreneur submitting a business plan for a company to produce a new product or service, technology and market information, a financial analysis of the prospects of the venture, and the amount sought with source and use of funds. The venture capital due diligence process analyses the business, market potential, technology, management, and capital appreciation potential in order to make an investment decision. The decision-making has always been manual and almost always relies on the assessment of a few individuals within the venture firm who may or may not have subject matter expertise. Regardless, it has been shown that there is very little correlation between venture characteristics, entrepreneur capability, product/service and technology and the actual venture investment appreciation, and therefore, there is no predictable way to estimate the probability of success of a venture from an investment growth point of view. No wonder less than 20% of all venture capital firms have been able to demonstrate a successful investment track record of wealth creation for their investors. The prior art of venture investment decision-making and evaluation is fairly manual, inefficient, not easily replicable, and has no dependable correlation to success factors.

Crowd funding is a new way for entrepreneurs with ideas and to be able to present their company, venture, project, or product/service solution over the internet to the crowd in order to attract small amounts of investment funding directly from large numbers of individuals. This is unlike the traditional process of an entrepreneur pitching to a venture capitalist to raise a large sum of money from a single investment fund of the venture firm, and the firm making the decision to invest in the company through one of the funds they manage for their accredited investors. In contrast, crowd funding is where the company approaches thousands of small investors to directly invest small amounts of money into the company. Most crowd funding business models today, however, are ‘donation-based’. They provide rewards in exchange for a contribution.

Nonprofit entities engage in fundraising typically via donations only. The funds raised by them are utilized for one of three purposes—fund-raising activity, administration, and operations. Typically, nonprofits fulfill their primary objectives via operations, whether it is to provide food, shelter or medicine to those in need, or to make grants to a university for research on the cure for an illness. The prior art of funding for nonprofits typically has been to raise capital through donations using capital campaigns via mail, email, phone, advertising or the Internet, and the utilization of funds is typically for one of the three purposes mentioned above. Fund raising costs are usually high and uses the available funds for operations that are used for fulfilling objectives to be reduced.

Corporate development departments make strategic investments in startup companies, but the prior art here once again relies on the process of entrepreneurs approaching potential strategic investors with a pitch for strategic equity investment. And, just like in the case of venture capital, the decision-making and evaluation process is manual, inefficient, not easily replicable, and has no dependable correlation to success factors.

### SUMMARY OF THE EMBODIMENTS

Some embodiments provide a processing system and method that focuses on crowd funding of private equity investment by automating the decision-making process as well as the process of private equity subscription and investment allocation based on specific attributes including the alignment of product/service benefit and consumption among other factors as it relates to companies, ventures and projects. The attributes are the basis of forming clusters/groups of information and meta-information that are aligned to other such clusters based on attributes of the various participating investor groups and matched. The system includes a payment processing system for immediate purchase of equity shares or convertible debentures.

The system preferably utilizes prior knowledge of alignments and tracks metrics such as gross profit contribution per employee, sales growth rate contribution per employee, and firm valuation per employee of the companies, ventures and projects in real time based on actual performance relative to what was predicted at the time of listing in a closed loop feedback incorporating the information dynamically so as to form more appropriate linkages while generating future clusters.

Effective matches may be made between unaccredited individual crowd investors, whether or not in conjunction with strategic institutional/nonprofit investors, and entrepreneurial companies, ventures, and projects that seek an investment. This enables the investors to make a direct investment to purchase private equity instruments such as equity shares, options, convertible debentures or other financial derivatives in such companies, and to do so with greater confidence of venture success. Recommended investments are expected to be more capital efficient than what is possible with other systems and methods of the prior art. Illustrative embodiments also combine and automate multiple and new functionalities that were thus far either done in disparate systems that were not coordinated, done manually, or not done at all.

Another objective of various embodiments is to interconnect to a product listing and procurement system so that all participants comprising investors groups and entrepreneur companies can purchase products produced by all companies within the network at a preferential low pricing due to private access. Such embodiments thus allow individuals, institutional organizations and entrepreneurial companies an opportunity to purchase all products produced at a low cost while creating new demand for the consumed products.

Some embodiments permit the dividend payment to unaccredited crowd investors in the form of rewards, credits and allowances equivalent in value to their original investment for future purchases from the interconnected product listing and procurement system.

In one embodiment of the invention, a method of operating an equity crowd funding system with different types of investors registers a company with an equity crowd funding system. The method registers first and second investors with the equity crowd funding system. Each of the first and second investors is an unaccredited investor, an accredited investor, an institutional investor, a non-profit investor, or an entrepreneur. Further, the first and second investors are different types of investors. The method sends to the first and second investors offers for equity holdings in the company in exchange for funds.

In sending the offers for equity holdings, the method may send offers for equity shares, options, convertible debentures, or other financial derivatives in the company. The method may receive a first payment from the first investor. In these embodiments, the first investor is an institutional investor and the first payment constitutes acceptance of the offer. The method may also receive a second payment from the second investor. In these embodiments, the second investor is an unaccredited investor or an accredited investor, and the second payment constitutes acceptance of the offer.

The method may also send to the second investor an offer from the first investor to purchase equity holdings in the company owned by the second investor. The method may receive from the second investor an automatic acceptance of the offer for the equity holdings in the company owned by the second investor.

In various embodiments, an apparatus with at least one processor and at least one memory is encoded with instructions. Execution of the instructions by the at least one processor causes the at least one processor to perform any of the steps described above. Further, a computer program product includes a non-transitory computer-readable medium having computer code thereon for recommending a business for investment. The computer code includes program code for performing any of the steps described above.

### BRIEF DESCRIPTION OF THE DRAWINGS

The foregoing features of embodiments will be more readily understood by reference to the following detailed description, taken with reference to the accompanying drawings, in which:

FIG. 1 depicts an exemplary architecture of the crowd funding private equity investment processing system of the invention;

FIG. 2A is a schematic overview of the unaccredited investor user workflow according to an exemplary embodiment;

FIG. 2B depicts the unaccredited individual crowd investor system process steps according to an exemplary embodiment;

FIG. 3 is a schematic flow diagram depicting an exemplary method of crowd funding;

FIG. 4 is a private equity investment data flow diagram in accordance with an exemplary implementation of the invention;

FIG. 5A depicts a summary of the deal flow process steps as it relates to private equity investment data flow according to an exemplary embodiment;

FIG. 5B depicts exemplary stages of private equity deal flow processing;

FIG. 6 is a diagram depicting exemplary different connected groups;

FIG. 7 is a screen display of the visual survey generator representing an exemplary implementation of the invention;

FIG. 8 is a screen display of company list view within the crowd funding private equity investment system representing an exemplary implementation of the invention;

FIG. 9 is a screen display of due diligence checklist associated with each company seeking funding within the crowd funding private equity investment system representing an exemplary implementation of the invention;

FIG. 10 is a screenshot of a deal round detail view within the crowd funding private equity investment system representing an exemplary implementation of the invention;

FIG. 11 is a schematic flow diagram of an exemplary interactive visual survey generator;

FIG. 12 is a flowchart diagram showing the integration of a product listing and procurement system with the crowd funding private equity investment system as an exemplary implementation of the invention;

FIG. 13 is a schematic diagram illustrating an exemplary planning loop structure;

FIG. 14 is a screen display of vendor information management by company within the admin section of the product listing & procurement portal of the crowd funding private equity investment system representing an exemplary implementation of the invention; and

FIG. 15 is a flowchart diagram depicting a method of paying dividend to unaccredited individual crowd fund investors in an exemplary implementation of the invention.

### DETAILED DESCRIPTION OF SPECIFIC EMBODIMENTS

Definitions. As used in this description and the accompanying claims, the following terms shall have the meanings indicated, unless the context otherwise requires:

“Crowd funding” refers to an on-line group of accredited, unaccredited, and/or institutional investors that pool resources to invest in business (e.g., invest in entrepreneurs, companies, ventures, and projects).

While many of the existing systems and methods for various groups, as they relate to private equity investment in small companies and/or startups address some of the issues independently, one problem is that the process is mostly manual as the information of interest lies in a complex web of human knowledge and experience and in dynamic databases that are separate and not connected. As a result, they cannot be used in a coordinated or automated manner to make assessments and deliver solutions that are predictable and reliable. Illustrative embodiments address this problem of making coordinated investments with information processed in a manner so as to render them more readily usable and predictable, and preferably with a reasonable measure of venture success among other factors. This should help the crowd to make better judgment calls while selecting projects, and reduce their risk while investing online in a crowd funding platform. Illustrative embodiments also create an efficient economic ecosystem that overlays traditional venture capital processes on existing crowd funding mechanisms, and integrates them with corporate, institutional, and nonprofit workflow in beneficial way.

As an example, a nonprofit may make a small investment in a venture to produce solar LED lights that replace kerosene lanterns in Africa. That investment may lead to an improved product at half the cost of its current equivalent. The nonprofit would not only realize a return that would replenish and grow its endowment, but with the same resources be able to help twice as many villagers to read, study, work, and improve their lives. Entrepreneurs would be able to develop and scale their projects. Additionally, crowd investors would experience value creation. The creation of the processing system and method for crowd funding private equity investment is an advance that will have a wide range of uses and applications.

Systems of the prior art known to the inventor do not include non-financial factors that are also important determinants of venture success. Those systems also do not consider product/service consumption patterns of the investors that could positively affect demand. Those prior art systems also do not automate the complete investment lifecycle from business plan to the equity sale to individual investors with real time payment processing, nor do they connect multiple investor groups with multiple entrepreneurial private equity investment opportunities simultaneously. Lastly, such prior systems do not automate the decision making process for matching investors with entrepreneurial companies. Another major difference is that such prior art systems are designed for interaction with accredited investors without any payment processing being done online. In fact, none of them include any participation by unaccredited individual crowd investors who have a need for the ability to invest small amounts of money with real time payment processing interconnected to the system similar to how it works for consumer e-commerce.

Further, prior art systems known to the inventor do not match a crowd investor's individual preferences to equity investments available that have undergone due diligence or been rated and evaluated with recommendations and valuations assigned based on a due diligence process. Due to recent changes in the law, the general public will soon be allowed to invest in startup companies over the Internet, and entrepreneurs will be able to raise capital online

Illustrative embodiments recommend businesses (e.g., projects, enterprises, corporations, LLCs, etc.) to investors for investment, and the investors may provide funds in exchange for equity shares in the business. To that end, prospective investors enter extensive data about themselves into the investment processing system/crowd funding system. The system processes the data to create a unique profile for each unique investor. Businesses seeking funding also enter extensive data about themselves into the system, which the system also processes to create a unique profile for each unique business. Then, the system determines which investor and business profiles best match one another. Thus, when an investor uses the system, the system presents the businesses whose profiles best match the investor's profile as investment recommendations.

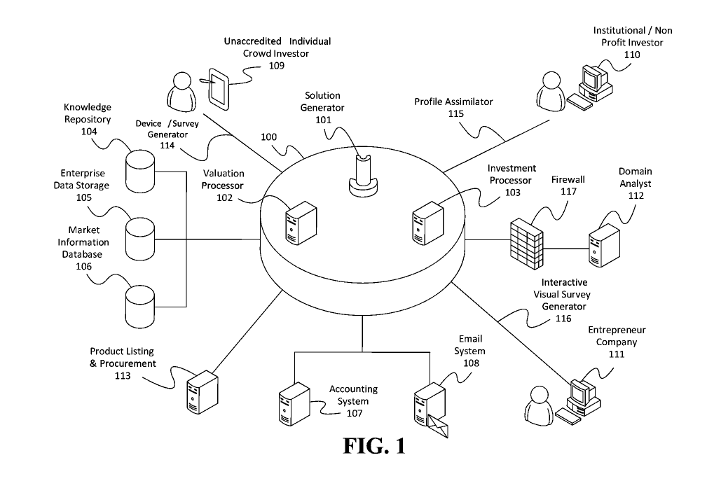

FIG. 1 is a diagram of the architecture of the crowd funding private equity investment processing system 100 according to an exemplary embodiment. The crowd funding private equity investment processing system 100 preferably is an entirely or mostly automated system that operates on one or more computing devices interconnected via a network that processes decision-making to match individual and institutional investors with entrepreneurs, companies, ventures, and projects (all referred to as “companies” or “businesses”) for crowd funding. The system also automates the share subscription, allocation and sale process to unaccredited individual crowd investors, as well as to institutional and non-profit investors who participate in the investment rounds of such companies. Users of the system include individuals who are members of the system, or registered as crowd investors, entities within organizations such as entrepreneur companies, ventures, or projects, and entities within organizations that function as strategic institutional investors or non-profit investors. Entities of companies and institutional/nonprofit organizations may be provided rights via a registration process, with or without payment of a sign-up fee, to access the crowd funding private equity investment processing system 100 in specific roles.

In various embodiments, a solution generator 101 processes groups of information and linkages based on information received from a valuation processor 102 (described below) and an investment processor 103 (described below). The solution generator 101 delivers recommendations based on groups of information with the highest “coefficient of determination” of the various indices; i.e., these recommendations are delivered based on values, referred to as “relationship values,” (discussed below) which correspond to a relationship between the investor and a unique business. These coefficients are computed to facilitate closing of the private equity investment cycle for unaccredited individual crowd investors and institutional/nonprofit investors in companies through multiple rounds of funding. Note that although it applies to unaccredited individual crowd investors, some embodiments also apply to accredited individual crowd investors.

The solution generator 101 may also process information provided by an unaccredited individual crowd investor computer device 109 via an input device or a survey generator 114, which receives the information via a survey. The solution generator 101 performs the processing based on a variety of different types of information, such as the unaccredited individual crowd investor's role, expertise, interest in product/service, and amount available for investment commitment.

The unaccredited individual crowd investor information is formed into groups of information that allow such information to be mapped, by the solution generator 101, to groups of information about the companies. Among other things, such information is received from the valuation processor 102 and the investment processor 103, based on planning loop structures.

In many embodiments, the valuation processor 102 processes information provided by an entrepreneur/company computer device 111 via an interactive visual survey generator 116. The information regarding the company may include information important to a potential investor, such as product/service domain, social benefit, economic feasibility, technology, management expertise, any combination thereof, or other information as would be appreciated. Additional information may be fed into the valuation processor from a knowledge repository 104 (described below), an enterprise data storage 105 (described below), and a market information database 106 (described below) (e.g., information relating to the financial and market pertaining to the company and industry). Some embodiments use a mathematical function to determine various secondary data that further assists with determining appropriate investments. For example, such a function may include a multi-dimensional second order polynomial mathematical equation that determines values for the probability of venture success, intellectual property advantage, and social good effect for each company. The valuation processor 102 provides these values together with other information as groups of business data to the solution generator 101.

In a similar manner, the investment processor 103 processes information provided by an institutional/nonprofit investor computer device 110 via a profile assimilator 115. The information may relate to the focus area, product/service domain, consumption volume, resources, and/or timeline of the institutional/nonprofit investor. Additional information relating to the institution or non-profit may be fed into the investment processor 103 from the knowledge repository 104, the enterprise data storage 105 and the market information database 106. A mathematical function, such as a multi-dimensional second order polynomial mathematical equation, may be used to determine values for risk tolerance, alignment of product/service, and benefit evaluation. The investment processor 103 provides these values together with other information as groups of investor data to the solution generator 101.

The solution generator 101 may include a recommendation engine capable of providing feedback to the computer devices 109 and 110 after processing results. Alternatively, the solution generator may itself be a recommendation engine.

In an exemplary embodiment, the crowd funding private equity investment processing system 100 may connect a computer device 112 operated by a domain analyst via a firewall 117. The computer device 112 may accept input from one or more domain experts and send the inputs directly to the solution generator 101. The solution generator 101 uses such inputs when determining groups of business data so that the groups can account for current business, industry and market experience.

The solution generator 101 may also access information from a relevant accounting system 107 and link references from the email system 108 in the meta-information of the groups of information.

The crowd funding private equity investment processing system 100 may connect to a product listing and procurement system 113. In this system 113, select products produced by the company are listed as available for purchase by any member with a log in to the system 100—unaccredited individual investors, institutional/nonprofit investors, or any company. Thus, the product listing and procurement system 113 is a virtual private marketplace that enables all users of the system 100 to participate in consumption at preferential reduced pricing while simultaneously promoting the demand creation and consumption of the listed products, benefiting the companies that produce them with incremental sales from the private marketplace.

The network over which the crowd funding private equity investment processing system 100 is interconnected may include the Internet, a public and/or private intranet(s), an extranet(s), a dedicated communication line(s) and/or any other configuration to enable transfer of data and commands including wireless networks.

The crowd funding private equity investment processing system 100 may itself be implemented as a funding portal.

The solution generator 101, valuation processor 102 and investment processor 103 may be any form of a computing device capable of receiving requests and transmitting responses over the network, such as a server capable of executing instructions to enable operation of the crowd funding private equity investment processing system 100.

The computer devices 109, 110, 111 and 112 and the input devices referred to such as 114 may be any device with data viewing, data modification, and data manipulation capability that is also able to communicate over the network. Examples of computer devices include a terminal, a laptop computer, a desktop computer, a mini server, a netbook, a smart phone, a tablet and an e-reader.

The knowledge repository 104, the enterprise data storage 105, and the market information database 106 may be databases, such as a relational database, that allow data storage capability. The databases may also allow storage of data utilized or generated during operation of the solution generator 101 or the recommendation engine within/part of the solution generator 101.

The product listing and procurement system 113 may be implemented as a private-sale e-commerce site, a private-sale m-commerce site, a web-based portal, as one or more apps for smart phones/mobile devices and tablets, or as a computer-based software program.

Of course, those skilled in the art can implement the various components of FIG. 1 in other manners that effectuate the underlying function of various embodiments. Accordingly, discussion of specific implementations is for illustrative purposes only and not intended to limit various embodiments of the invention.

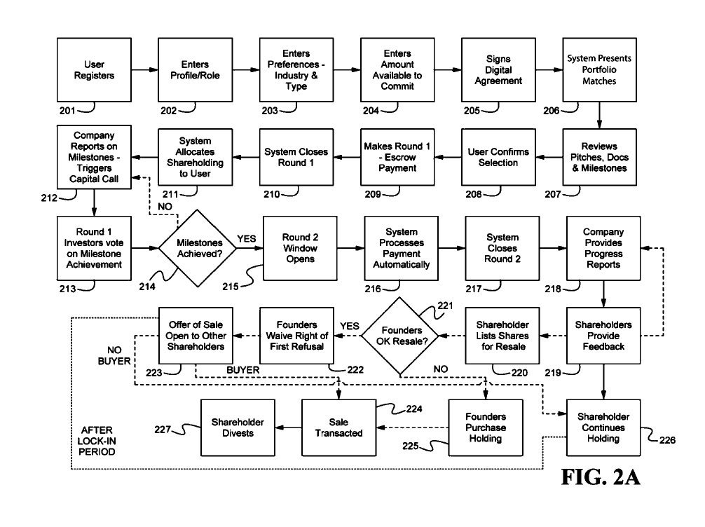

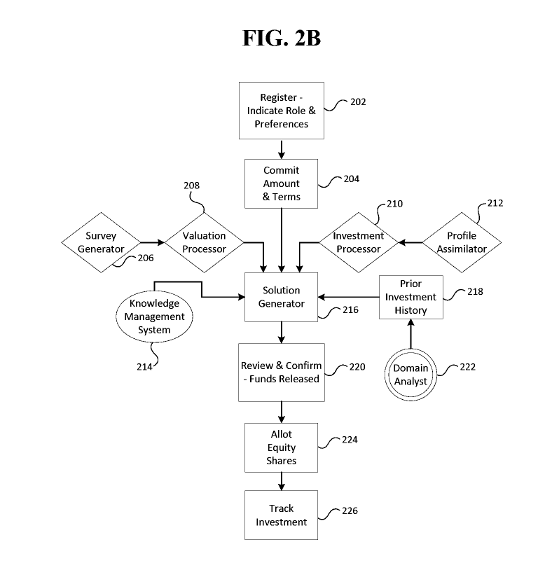

FIG. 2A is a schematic overview of the unaccredited investor user workflow according to an exemplary embodiment. Specifically, this workflow outlines steps involved and the user experience in a web-based implementation of the system by an unaccredited individual crowd investor from registering, selecting a company for investment, making a payment to close a round of investment, through ultimately transacting the investment.

The process begins with the unaccredited individual crowd investor registering as a user 201, entering a profile 202, together with industry, product and other preferences 203, the amount available for commitment to invest 204, and then signing a digital agreement 205. At this stage of the workflow, the system accepts the registration, uses the investor information provided and presents matches from companies for investment consideration 206. The unaccredited individual crowd investor then reviews the recommendations of the investment opportunities 207 with any second level details available, such as a presentation, business plan, executive summary, and milestones to confirm an investment selection 208 and make a payment 209. The system then processes all unaccredited individual crowd investor payments to close the investment round 210 and allocate the appropriate equity investment or shareholding for the investments 211. Then, the company reports on milestones 212. Some or all unaccredited individual crowd investors of the company review the milestone report and vote on whether they believe the company has achieved objectives stated at the time of original investment 213. In some embodiments, the unaccredited crowd investor votes electronically with the click of a button. If some prescribed percentage (e.g., 51%) of the crowd investors vote that the milestones have been achieved 214, the system opens the second round of investment 215, and processes payment from unaccredited individual crowd investors 216 to close the round 217. The company continues to provide progress reports and updates to investors 218. Investors have opportunities to provide feedback to the company 219, continue holding the shares or other private equity investment instrument 226, or list their equity for resale 220. If investors seek to list their equity for resale, then the founders may either offer to purchase the holding 225 or waive the first right of refusal 222 so that the offer of sale can be opened up to other shareholders 223. When a sale of an unaccredited individual crowd investor holding is transacted 224, the investor divests 227.

FIG. 2B depicts the unaccredited individual crowd investor system process steps according to an illustrative embodiment showing a summary of the actions of the user and the system. To that end, the user registers 202, and then commits to an amount of investment 204. Next, this information is forwarded to the solution generator 216.

The solution generator 101 also receives data from the valuation processor 208, the investment processor 210, and a knowledge management system 214. The solution generator 101 also receives histories of information relating to prior investments 218 from earlier investors and domain analysts 222. Thus, prior positive experiences and outcomes of crowd investors and domain analysts with respect to various companies listed within the system 100 are incorporated into the methods for assessing businesses and providing recommendations.

In some embodiments, unaccredited investors may enter valuations of different listings of companies, ventures or projects into the system. The valuation processor 102 may give greater weight to more experienced investors and investors who have commitment larger sums of funds to investment. In some embodiments, the valuation processor 102 may exclude inputs from new or otherwise inexperienced investors. The resultant weighted average valuation may provide a better assessment of the valuation of a particular deal, and consequently its pricing relative to the offering price, thus helping unaccredited crowd investors assess from a collective pool of investor input whether a specific company, venture, or project is attractively priced. In some embodiments, this information is entered via a domain analyst window 222, because previous investors who chose to provide valuations also act in the role of analyst when providing such information. This information may also be combined with subject matter experts and institutional investors so that a collective valuation is available to all those who view the listing of the company, venture or project.

The investment opportunity is then reviewed and confirmed by the unaccredited individual crowd investor 220, and the equity shares allotted 224 once the listing of the issue is subscribed. Then, the investors can track their investment 226.

Stated another way, in operation, the solution generator 101 or investment processor 103 receives information about an investor and creates investor profiles accordingly. The investor may be an unaccredited individual crowd investor, an institutional investor, or a non-profit investor, although other types of investors may subscribe to the service.

The solution generator 101 or investment processor 103 may receive the information from various sources. For example, the solution generator 101 may receive information about an unaccredited individual crowd investor from answers to a survey created and presented by a survey generator 114. The unaccredited investor may input answers via an input device. In another example, the investment processor 103 may receive information about an institutional or non-profit investor from information inputted into a profile assimilator 115. Exemplary information about an institutional or non-profit investor include their focus area, product domain, service domain, consumption volume (e.g., likelihood to consume products or services of a business seeking investment), resources (e.g., amount of investment commitment), and timeline for investment. Further exemplary information, which may be about institutional, non-profit, or individual unaccredited investors, may include investor age, education, expertise, profession, prior investment experience, risk tolerance, annual investment capacity, expectation of returns, accreditation or lack thereof, and interest in purchase or use of products and services.

In some embodiments, the solution generator 101 or investment processor 103 may derive information about the investor (e.g., secondary information) from the collected information (e.g., primary information). For example, the solution generator 101 or investment processor 103 may analyze an investor's investment history to identify products or services related to previous investments as potential businesses of interest. Based on an institutional investor's previous investment in blood glucose monitors, the solution generator 101 or investment processor 103 may identify businesses developing new types of blood glucose test strips as potential businesses of interest. In another example, the solution generator 101 or investment processor 103 may determine that an investor has been increasing the size of their individual investments. If the size of an investor's individual investments has been increasing by 10% annually for the past three years, the solution generator 101 or investment processor 103 determines that the investor may be willing to provide funding at 10% above its commitments in the prior year, regardless of the investor's on-paper amount of available funding.

The solution generator 101 or investment processor 103 creates a group of investor data from the information about the investor. This group of investor data may correspond to a profile of the investor. In some embodiments, the group of investor data is a subset of the information collected from the investor by the solution generator 101 or investment processor 103. The group may include collected information and information that was derived from the collected information.

Among other things, the solution generator 101 or investment processor 103 may determine values corresponding to an investor's risk tolerance, alignment of product, alignment of service, and/or benefit evaluation based on any of the information obtained about the investor. Such values may be used in creating the group of investor data. In some embodiments, the investment processor 103 determines any of these values according to a mathematical function, such as a multi-dimensional second order polynomial mathematical equation.

The valuation processor 102 receives information about businesses and creates business profiles accordingly. A business may be a company, a venture, or a project, although other types of businesses may subscribe to the investment processing system's 100 service.

Information about a business may come from various sources. For example, personnel for a business may input answers to a survey created and presented by a survey generator 116. The business may input answers from its own computer device. Exemplary information obtained from the business itself may include information on the business's product or service domain, social benefits, economic feasibility, technology, and management expertise of personnel. In further embodiments, the knowledge repository 104, the enterprise data storage 105, and the market information database 106 sends information about businesses to the valuation processor 102. Exemplary information obtained from these sources may include financial and market information about the business and/or its industry sector. For example, the information may include an analysis of the business's target market, including potential and/or projected demand for the business's products or services.

In some embodiments, the valuation processor 102 may derive information (e.g., secondary information) about a business from the collected information (e.g., primary information). For example, the valuation processor 102 may determine how quickly the business is increasing revenue by calculating the rate of change in sales growth. In another example, the valuation processor 102 may determine how efficiently the business is using its capital by calculating the ratio of the business's revenue to expenses, or the rate of change for this ratio. Further, the valuation processor 102 may determine how quickly the business is expanding by calculating the rate of change in the company's headcount. In another example, the valuation processor 102 may estimate the date that the business will become financially solvent/profitable based on the business's burn rate (e.g., expenditures) and rate of revenue growth. In addition, information regarding expected expenditure increases as the company grows (from the knowledge repository 104, by way of example) may be used in conjunction with such information to estimate the business's future prospects and in turn, the rate of return on the investor's funding.

Further, domain analysts may evaluate and/or rate various business models and send the same to the valuation processor 102. The processor 102 may store these evaluations and ratings with the other information for businesses.

Using the collected and derived information about the businesses, the valuation processor 102 may create groups of business data. In some embodiments, a single group of business data may correspond to a profile of a business, whereas in other embodiments, multiple groups of business data correspond to the profile of a business.

The valuation processor 102 processes the collected and/or derived information about the businesses to create groups of business data. In some embodiments, the valuation processor 102 analyzes the information to detect patterns. Based on the analysis, a group of business data may include collected information about a business, information derived from the collected information, or both. For example, a group of business data may include a subset of the information collected from the business by the valuation processor 102. A group may include all of the collected and derived information.

When creating groups of business data, the valuation processor 102 may use values corresponding to a business's probability of venture success, intellectual property advantage, and/or social good effect when creating the groups of business data. Any of these values may be based on any of the information regarding the business. In some embodiments, the valuation processor 102 determines the values from information collected from the survey generator 111, whereas in further embodiments, the valuation processor 102 also uses financial and market information obtained from the knowledge repository 104, the enterprise data storage 105, and the market information database 106. The valuation processor 102 may determine any of these values according to a multi-dimensional second order polynomial mathematical equation.

Groups of business data may also be created based on or including one or more success metrics. In some embodiments, the valuation processor 102 determines values corresponding to an investment metric (e.g., an investment index), a liquidity metric (e.g., a liquidity index), and a valuation metric (e.g., a valuation metric) for each business. In some embodiments, each of these metrics is determined according to a mathematical function, such as a different multi-dimensional second-order polynomial mathematical equation (see below), and each may be used in creating one or more groups.

In some embodiments, when a business's profile includes multiple groups of business data, the valuation processor 102 determines a unique weight for each group based on any of these metrics. For example, the weight may account for the gross profit contribution per employee of a business, sales growth rate contribution per employee of a business, or firm valuation per employee of a business, either in addition to the other metrics or on their own.

To determine the best matches between investors and businesses, the solution generator 101 determines the above noted relationship values. Each relationship value corresponds to an investor-business pair, and the magnitude of this value indicates the degree to which the investor and business match. For example, when a business's sector, expected rate of return, anticipated risk, and capital requirements are closely matched to an investor's corresponding sectors of interest, desired return on investment, risk tolerance, and amount committed to funding, the relationship value between the particular business and investor may be high. If the investor's sectors of interest are related to, but not the same as, the business's sector, the relationship value may be lower.

This matching preferably is empirically determined. Thus, data in each group of data may be assigned numerical values. Investor values that are close to business values may yield a high number for that type of data. For example, the level of risk the investor may be willing to accept may be high. In that case, on a scale from 1-10, the risk tolerance of the investor may be set at 10. Corresponding businesses having risk factors of 10 (on a 1-10 scale) thus best match the risk tolerance of the investor. Such a match may be assigned a “matching value” of 100 (representing a 100% match). If the risk factor of the business is a 9, for example, then the match may be assigned a matching value of 90. If this factor is weighted, then the matching value of 90 or 100 will be scaled up or down based on the weighting. For example, if the risk is weighted 3× or 0.5×, then the matching value may be multiplied by this weighting factor. This process continues for all relevant data values, and the individual matching values may be incorporated into a mathematical formula, such as a simple formula that sums all the matching values.

The solution generator 101 determines a relationship value for an investor-business pair based on the related group of investor data and group(s) of business data. In some embodiments, the relationship value includes the coefficient of determination of the investment metric, the liquidity metric, the valuation metric, or any combination thereof. Groups of business data and their weights may be processed along with the group of investor data to determine the coefficient of determination.

To make investment recommendations, the solution generator 100 selects the businesses whose relationship values with respect to a particular investor have the highest values. The solution generator 100 may rank the businesses and select the top one, two, three, five, ten, or some other number, for presentation as recommendations to the investor, displaying the recommendations on the investor's computing device. For example, the solution generator 101 may list three potential businesses having the highest three relationship values for a given investor. This should provide three recommended businesses for the investor from the many others in the system.

In some embodiments, domain analysts may input information to the solution generator 101. In other embodiments, the solution generator 101 may receive historical information about prior investments regarding investors using the system 100. In response, the solution generator 101 may adjust the relationship values of various investor-business pairs such that the values incorporate new data regarding the business, industry, and market. Alternatively, the solution generator 101 may adjust groups of business data according to the input from the domain analysts. Likewise, the solution generator 101 may update relationship values and/or groups of business data based on updated information from a knowledge management system.

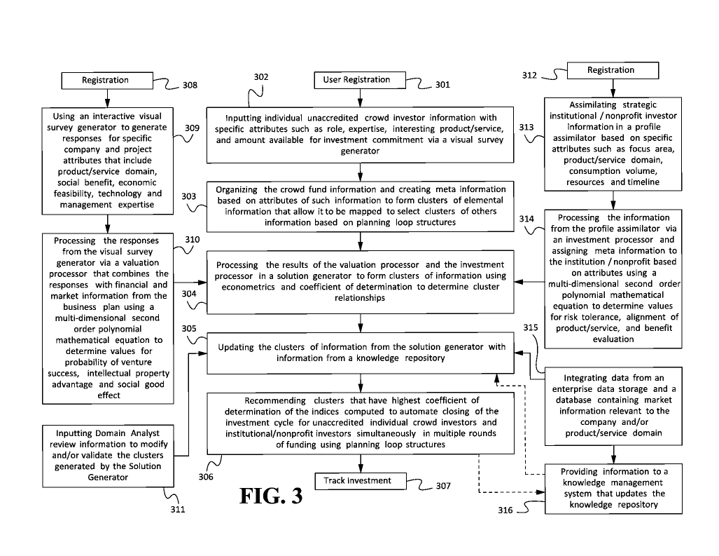

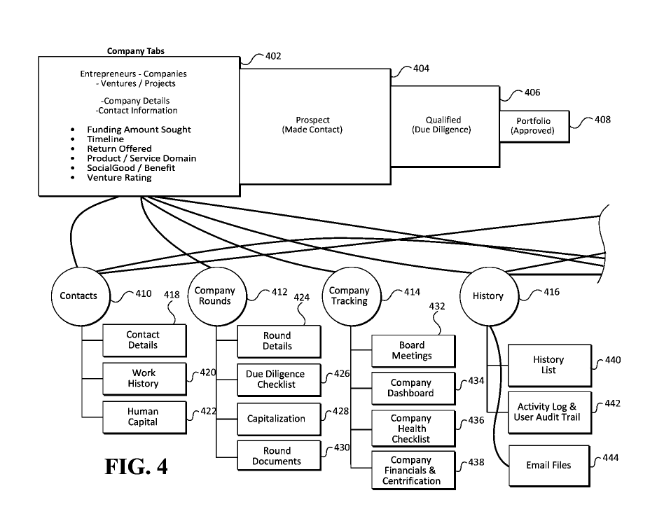

FIG. 3 is a schematic flow diagram depicting an exemplary method of crowd funding in accordance with illustrative embodiments. The steps utilized in the method include the steps of:

Inputting unaccredited individual crowd investor information such as role, expertise, interest in product/service, and amount available for investment commitment via a visual survey generator 302, based on a registration process,

Organizing the investor information and deriving information based on the received information to form groups of investor data that allow the data to be mapped to select groups of other information (i.e., business data for companies), based on planning loop structures 303,

Using an interactive visual survey generator to obtain information for companies, ventures, or projects, such as product/service domain, social benefit, economic feasibility, technology and management expertise 309, based on a registration process of companies, ventures and projects seeking funding 308,

Obtaining financial and market information from the business plan, registration process, and/or external data, and processing the company information, financial information, and/or market information using a multi-dimensional second order polynomial mathematical equation to determine values for probability of venture success, intellectual property advantage and social good effect 310,

Assimilating strategic institutional/nonprofit investor information in a profile assimilator based on information such as focus area, product/service domain, consumption volume, resources, and timeline 313, based on a registration process of strategic institutional and nonprofit investor organizations 312,

Processing the information from the profile assimilator (e.g., via an investment processor) and assigning values for risk tolerance, alignment of product/service, and benefit evaluation to the institution/nonprofit, the values obtained using a multi-dimensional second order polynomial mathematical equation and information about the institution/nonprofit 314,

Processing the results of the valuation processor and the investment processor in a solution generator to map groups of investor data to groups of business data, using econometrics and coefficients of determination 304, and

Recommending businesses whose groups of business data have the highest coefficient of determination of the indices (e.g., relationship values), consequently automating closing of the investment cycle for unaccredited individual crowd investors and institutional/nonprofit investors simultaneously through multiple rounds of funding using planning loop structures 306.

The method may also include the steps of:

updating the groups of business data from the solution generator with information from the knowledge management system, which in turn is interconnected to a knowledge repository and updated in a closed loop 305,

inputting domain analyst review information to modify and/or validate the groups generated by the solution generator 311,

integrating data from an enterprise database and a database containing market information relevant to the company and/or product/service domain 315, and

providing information to a knowledge management system for updating of the knowledge repository 316.

The investor information may be processed to calculate secondary data, such as a determination of the investor's risk tolerance, alignment of products or services, and benefit evaluation. These values, in combination with the investor information, may be processed to create one or more groups of investor data that correspond to a profile of the embodiments. A value of the investor alignment (e.g., the investor alignment index) may be calculated according to the following multidimensional second order polynomial equation:

$$f ( investor alignment index ) = {k}_{5} {X [ \begin{matrix}{( \# of times Prior Investments made in past one )}^{2} + \\ {( Risk Tolerance )}^{2} + \\ {( \frac{Annual Investments {Capacity}_{investor}}{Annual {Income}_{investor}} - 1 )}^{2} + \\ {( \frac{{Age}_{investor}}{{Age}_{ideal}} - 1 )}^{2} + \\ {( \frac{{Education}_{investor}}{{Education}_{ideal}} - 1 )}^{2}\end{matrix} ]}^{1 / 2}$$

Where f (investor alignment index) is a function of the number of times prior investments have been made in the previous year by the investor, the risk tolerance of the investor, the ratio of the annual investment capacity of the investor to the annual income, the investor age, and the investor income. Squaring the differential amplifies the deviation from the ideal or median, and the square root normalizes these deviations. Although one exemplary multidimensional secondary polynomial equation is presented here, other equations that rely on other information may also be used. Further polynomial equations or non-polynomial equations may be used to determine the benefit evaluation or any other metric, so long as the equations involve comparisons between ideal values for investors and actual values pertaining to the investors.

There are various factors that affect the success of a company, venture or project and influence private equity valuation. These are:

The idea or concept,

Management expertise,

Strategic customer relationship and/or consumption,

Market growth,

Competitive landscape,

Time to launch,

Organization cost,

Investment size,

Investment payback,

Revenue to investment ratio,

Steady-state EBIDTA, and/or

5 Year Valuation growth.

In various embodiments, groups of business data are formed based on (a) the idea/concept as evaluated and rated by domain experts (also referred to herein as domain analysts), (b) potential demand and market analysis with respect to the industry and product or service, and (c) “Success Factors,” which may be dependent on an ‘investment index’, a ‘liquidity index’, a ‘valuation index’, or any combination thereof.

The valuation index (also referred to herein as valuation metric) is a measure of the valuation-growth potential relative to an ideal target and computed by comparing the projected valuation growth curve of a company to a model curve, with the index value of 1 implying a perfect model fit curve. An exemplary equation for determining the valuation index is:

$$f ( valuation index ) = {k}_{4} {X [ \begin{matrix}{( \frac{{IS}_{company}}{{IS}_{ideal}} - 1 )}^{2} + \\ {( \frac{{ME}_{company}}{{ME}_{ideal}} - 1 )}^{2} + \\ {( \frac{{CL}_{company}}{{CL}_{ideal}} - 1 )}^{2}\end{matrix} ]}^{1 / 2}$$

Where f (valuation index) is the valuation index, IS_{company} is the investment size of the company and IS_{ideal} is the ideal or targeted investment size, where ME_{company} is the value assigned to management expertise of the company whereas ME_{ideal} is the ideal level of expertise that can be assigned for a similar size investment, and where CL_{company} is the competitive landscape of the company compared to an ideal competitive landscape CL_{ideal}.

The investment index (also referred to herein as an investment metric) may be a measure of is the quality of an investment in the company, based on available information at the time of the determination. The investment index is a function of three factors, viz.:

Investment Payback,

Revenue to Investment Ratio, and

Steady State EBIDTA.

In some embodiments, an investment with 1) lower investment payback, 2) higher revenue to investment ratio, and 3) higher steady state earnings before interest and tax for a company may have a high likelihood of being a relatively better investment, from a financial analysis standpoint. The valuation processor 102 of the system 100 in FIG. 1 computes the investment index of each company, venture, and project. As described herein, this index can be used to determine the weight of any given group of business data.

The liquidity index (also referred to herein as the liquidity metric) may be a measure of the likelihood that a company can cash out so that an investor is able to exit their investment. The liquidity index is a function of three different dependent factors, viz.:

Strategic customer relationship and/or consumption,

Market growth relative to the competitive landscape, and

Time to launch and organization Cost.

According to some, the larger the strategic customer consumption, the faster the market growth in a relatively less competitive landscape, and the smaller the time to launch and organization cost, the more likely the company will grow into a good acquisition candidate and therefore warrant a higher liquidity index. The valuation processor 102 of the system 100 of FIG. 1 computes the liquidity index for each company, venture and project according to the above logic.

“Value driven” companies may be defined as companies with significantly higher than the median market value ratios, and they have been found to have the following characteristics: (a) exceptional value propositions derived from creativity and changing trends that lead to unique products, services or target markets; (b) cohesive organizational structures that lead to flat organizations enabling efficient knowledge flow and execution; and (c) high sales-growth rates, at times coupled with high earnings growth rates. These characteristics, for the most part, are independent of each other.

Also, “market value per employee” as a metric helps determine the net incremental value addition per person employed in the organization, discounted by market forces. The gross profit contribution per employee has a significant impact on the per employee market value for small companies with fewer than 500 employees. The dependence of market value per employee is fairly high on one other key variable, the sales growth rate contribution per employee, with a R² of 0.56 across 471 observations. As such, these three additional metrics are also used in an embodiment of the invention to compute indices for weights of groups: (a) gross profit contribution per employee, (b) sales growth rate contribution per employee, and (c) firm valuation per employee.

The multi-dimensional second order polynomial mathematical equations used in illustrative embodiments thus consider as variables the investment index, the liquidity index, the valuation index, the gross profit contribution per employee, the sales growth rate contribution per employee, and the firm valuation per employee. An exemplary embodiment of a multi-dimensional second order polynomial mathematical equation is

$$f ( investment index ) = {k}_{1} {X [ \begin{matrix}{( \frac{{IP}_{deal}}{{IP}_{company}} - 1 )}^{2} + \\ {( \frac{{RIR}_{company}}{{RIR}_{ideal}} - 1 )}^{2} + \\ {( \frac{{SSE}_{company}}{{SSE}_{ideal}} - 1 )}^{2}\end{matrix} ]}^{1 / 2}$$

Where f (investment index) is the investment index, IP_{company} is the investment payback of the company and IP_{ideal} is the ideal or targeted investment payback, where RIR_{company} is the return on investment ratio of the company and where RIR_{ideal} is the ideal return on investment ratio desired, and where SSE_{company} is the steady state EBIDTA of the company while SSE_{ideal} is the ideal steady state EBIDTA desired. In this embodiment, the polynomial mathematical equation allows for relative magnification of a relative ratio of the metric, which allows the value to be more impactful in highlighting relative differences, when compared to an ideal or desired state. Similarly, the liquidity index may be computed using the equation

$$f ( liquidity index ) = {k}_{2} {X [ \begin{matrix}{( \frac{{SCC}_{company}}{{SCC}_{ideal}} - 1 )}^{2} + \\ {( \frac{{MG}_{company}}{{MG}_{ideal}} - 1 )}^{2} + \\ {( \frac{{SCR}_{ideal}}{{SCR}_{company}} - 1 )}^{2}\end{matrix} ]}^{1 / 2}$$

The success factor may also be computed by use of a different polynomial mathematical equation

f(success)=k₃{Vᵢ(Iᵢ+Lᵢ)²}

Where f (success) is the success factor, Vᵢ is the valuation index, Iᵢ is the investment index, Lᵢ is the liquidity index. In a similar manner, the gross profit contribution per employee, sales growth rate contribution per employee, and firm valuation per employee are factored into the quantification and weightage of clusters to determine relationships between investor and company clusters more accurately.

Further exemplary metrics used in creating groups of business data for companies include indices/metrics for venture success, intellectual property advantage, and/or social good effect.

In one embodiment, the venture success metric is dependent on the valuation index, the investment index and the liquidity index. The intellectual property advantage value may be based on the total number of patents applied for multiplied by the number granted. Other formulas that produce values reflecting the strength of the intellectual property portfolio may be used. Further, the social good effect may be a rating on a scale of 1 to 10, based on the amount of social impact the project is expected to have at steady state. Other formulas, such as multidimensional second order polynomial equations, may also be used for any of these metrics.

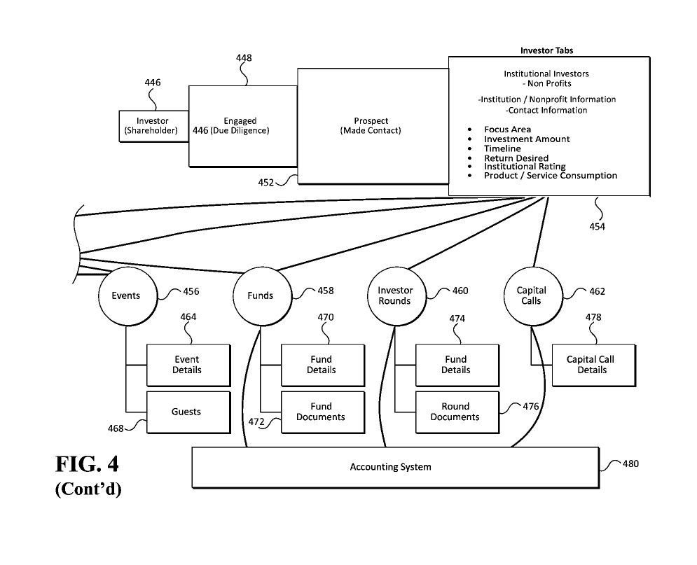

FIG. 4 is a block diagram of the data flow of the private equity due diligence process in an exemplary functionality of the private equity investment processing system 100. Companies 402 and contacts 410 are contacted 404, qualified based on discussions 406, and after a due diligence process approved as portfolio investments 408.

Second level details such as contact details 418, work history and experience 420 and human capital involved 422 are evaluated together with the due diligence checklist 426, round details 424, capitalization 428 and round documents 430.

On the other end of the spectrum, investors are tracked 454, followed up on 452, and engaged 448, to ultimately shortlist those who come in and invest in various funds as shareholders 446. Different investors 446 could be investors in different funds 458 and second level fund details 470 together with fund documents 472 are tracked. Investor rounds 460 via capital calls 462 are managed to keep the investor flow of capital, which are all recorded in the accounting system 480.

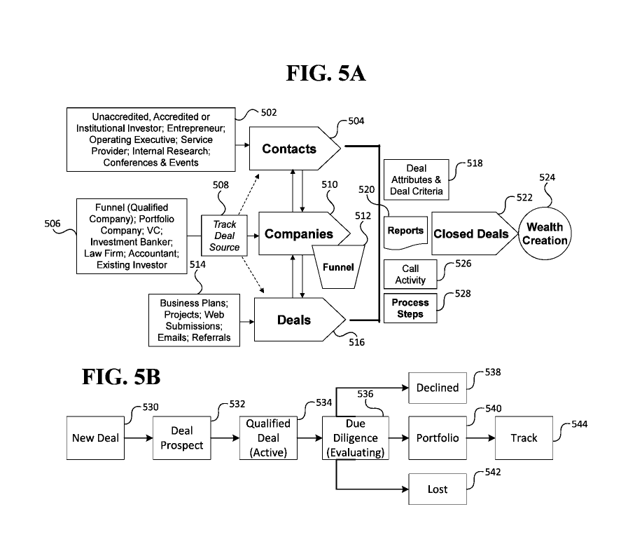

FIG. 5A depicts the summary of the deal flow process steps as it relates to private equity investment data flow according to an exemplary embodiment. Investors of all types, including unaccredited individual crowd investors, institutions, and entrepreneur contacts 504 are reviewed and qualified to shortlist funnel companies 512. The data is prepared with internal research 502 and listed with qualified companies 506 with tracking of deal source 508 and company details 510. Business plan documents 514 are reviewed and the companies that are converted into deals 516 are tracked for deal attributes and deal criteria 518. Reports 520, call activity 526 and process steps 528 are all part of the deal closing process 522 with the ultimate goal of wealth creation 524.

FIG. 5B depicts the deal flow process, which goes through various stages. First, a deal is identified and classified as a new deal 530. Then, after contact is made with the entrepreneur and company, it is validated and classified as a prospect 532. At this point, if a deal is not worthy of including in the system, it is not advanced to the next stage. The filtered list of qualified deals 534 is then examined in detail and evaluated via a due diligence process 536. This step helps evaluate a company's prospects for investment. Those companies whose deals undergo the scrutiny of due diligence successfully are classified as portfolio companies 540, ready for investment and tracking of their investments 544. Deals that do not survive the scrutiny are either declined 538, or they are abandoned or lost 542 in the process of due diligence. These process steps of advancing the deal cycle can be done manually, automatically, or a combination of both. The system records and tracks every detail which can be looked up at any time by anyone with access to the system and the rights to access such information.

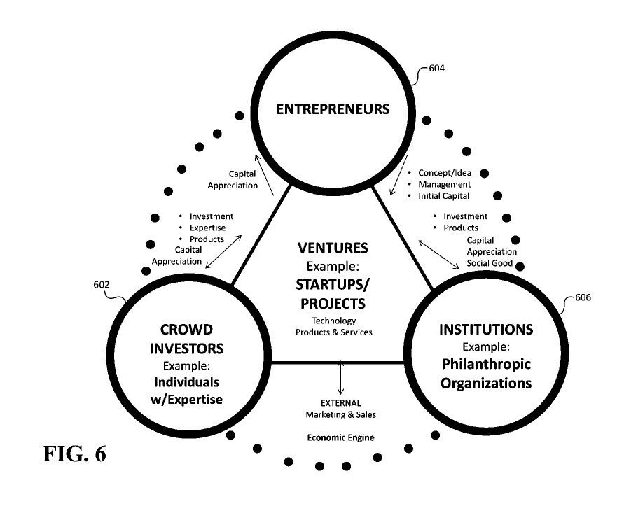

FIG. 6 is a diagram depicting the different connected groups of the invention. The different connected groups comprise crowd investors 602, entrepreneurs 604, and institutional investors 606, who are all brought together under one platform with relevant information from each group clearly visible to the others.

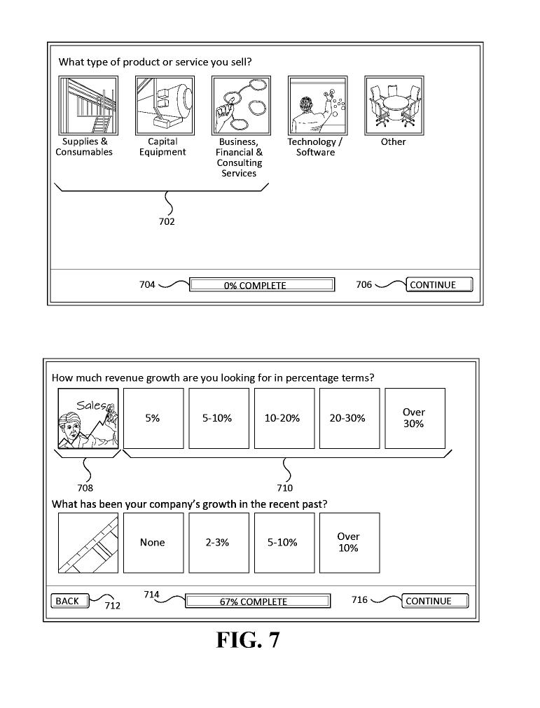

FIG. 7 is a screen display of the visual survey generator representing an implementation of the invention. The visual survey displays either just images 702, or combinations of images 708 and text 710, so that system uses may respond to surveys via simple inputs (e.g., mouse clicks). The progress bar 704 and 714 displays how much of the survey is complete. The user may click on the continue button 706 or 716 to advance to further questions. These visual survey generators quickly assimilate specific information visually and with click responses, and they may be much more efficient than standard questionnaires where a user has to either answer questions or select from a multiple choice of text only choices.

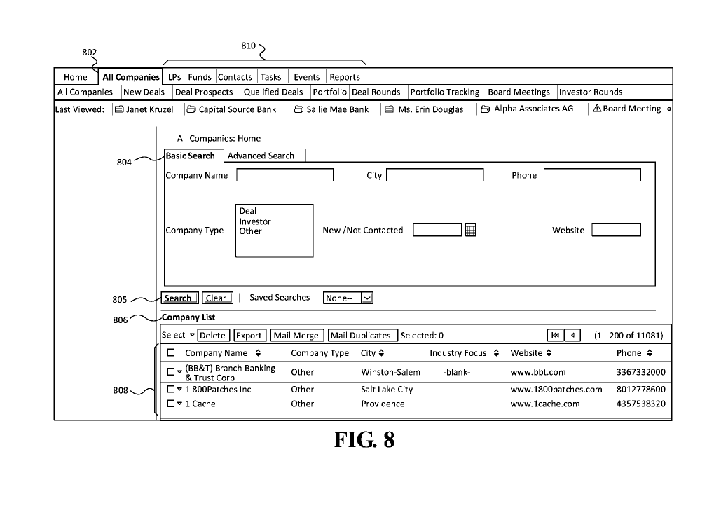

Referring to FIG. 8, a screen display of the Companies tab in an exemplary implementation of the private equity due diligence process described in FIG. 4 previously, showing a listing of All Companies 802, New Deals, Deal Prospects, Qualified Deals, Portfolio, Deal Rounds, Portfolio Tracking, Board Meetings and Investor Rounds that are stored for viewing and for management of the process. Clicking on the sub-tab All Companies displays a list view of all companies in the system that can be viewed as a company list 806 and that includes the company name, company type, city, industry focus, website and phone number in line format 808. Clicking on a specific company name to drill down provides additional details and displays many more details pertaining to the specific company. A user can also search for companies by entering the name, city, or company type in the search area 804 and clicking on the search button 805. A user can also view tasks, events, activities, reports, funds and LPs associated with the company 810 by either clicking on the respective tab or scrolling down below the company detail view for summary information once in the detail view of a specific company.

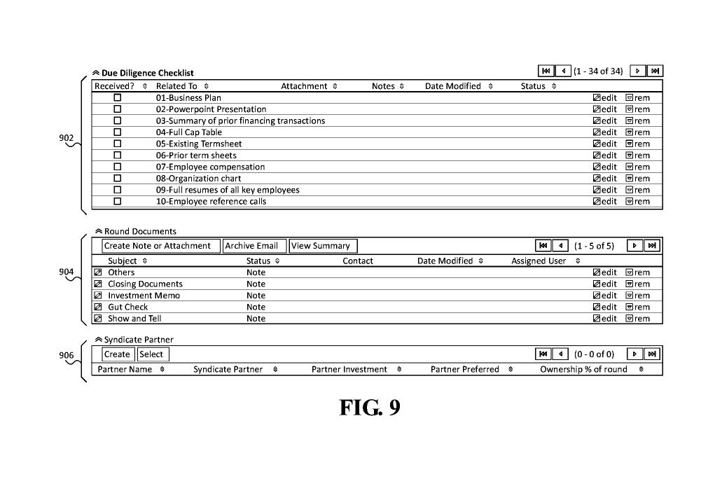

FIG. 9 is a screen display of the due diligence checklist 902 in an exemplary implementation of the private equity investment data flow diagram and due diligence process shown in FIG. 4. The due diligence 902 and round documents 904 associated with a deal round can be viewed by scrolling down below the deal round view and clicking on the appropriate links. Other details such as partners 906 can also be viewed in the same screen. Clicking on any of the links drills down further to display additional details.

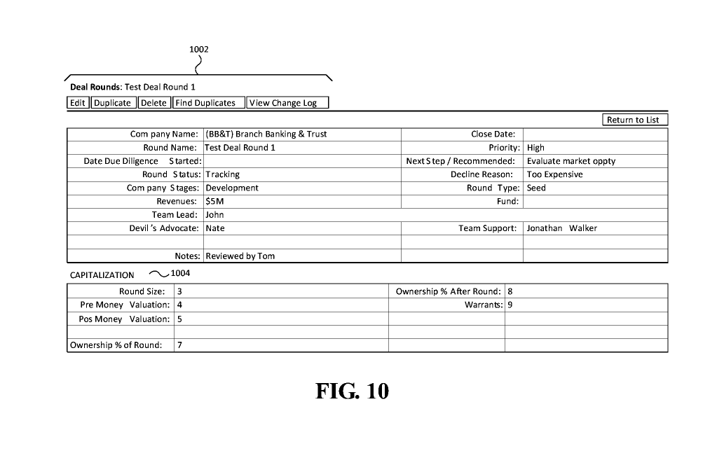

Referring to FIG. 10, a screen display of the deal round view 1002 can be seen in an exemplary implementation of the private equity due diligence process. Details such as the deal round name, company name and company stage are all stored and displayed. Clicking on a deal round name or company name allows one to view additional second level and third level details. The capitalization details 1004 are also stored and viewable in the screen. One can also search for deal rounds by round name or company name and by clicking search.

Similarly, many other functionalities of the private equity investment data flow process are part of the crowd funding private equity investment processing system 100 including portfolio tracking and second level details such as board meetings, capitalization tables, etc. A company's health checklist associated with the portfolio tracking is also available for viewing as a summary or with full details.

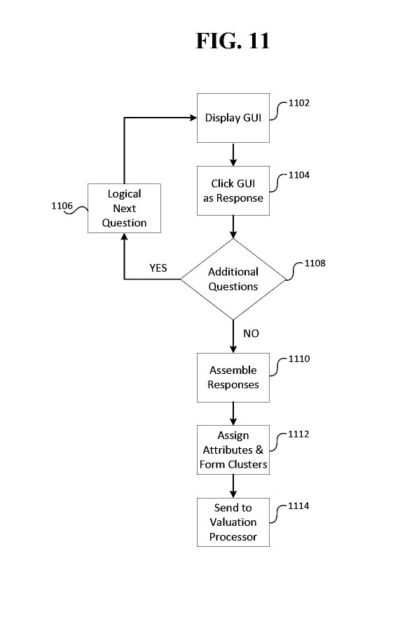

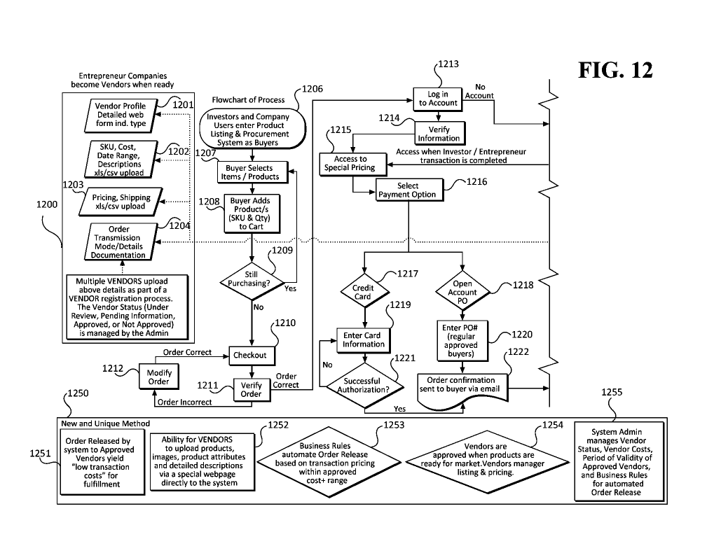

FIG. 11 outlines the schematic flow diagram of the interactive visual survey generator in accordance with illustrative embodiments of the invention. A graphic display or graphic user interface 1102 serves as a mode of visual communication to the viewer so that the viewer can respond via a click of the mouse 1104 and provide feedback to the system. Additional questions 1108 are asked with additional visual displays that can be clicked on and the collective responses are assembled 1110 to assign information and form groups 112 so that information can be sent on to the valuation processor 1114. The mere clicking of an image rather than filling in a detailed form as is normally done is the way the interactive visual survey generator works.

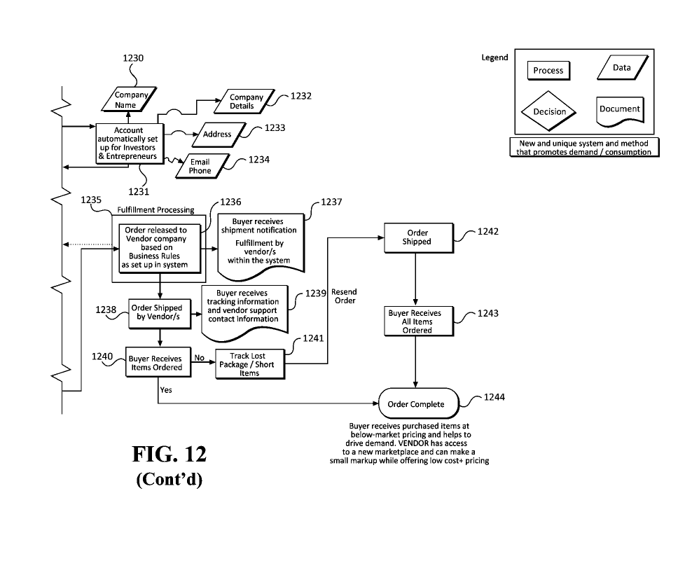

FIG. 12 is a flowchart diagram showing how the integrated product listing and procurement system ties with the crowd funding private equity investment system 100 in an exemplary implementation of the invention. When an entrepreneur company is funded by the system, a vendor details 1200 are provided via a vendor profile 1201 created by the entrepreneur company together with product details 1202, that list the products and services produced by such company and available for sale to other users of the system. Pricing and shipping charges 1203 are also entered into the system together with vendor order transmission details 1204. The system and method of the invention allows a company with products and services ready for market launch to become a vendor to all users of the system by listing the company's role as a vendor and offering select products and services to users of the system at preferential reduced pricing. Since the system already has product and service consumption information, and uses such information to match users with each other, this listing and procurement system ends up creating a new private marketplace for the users thus resulting in a new sales channel with no marketing or selling costs associated with it for the companies listing products. The flowchart of the buying process is shown in steps 1206 through 1244.

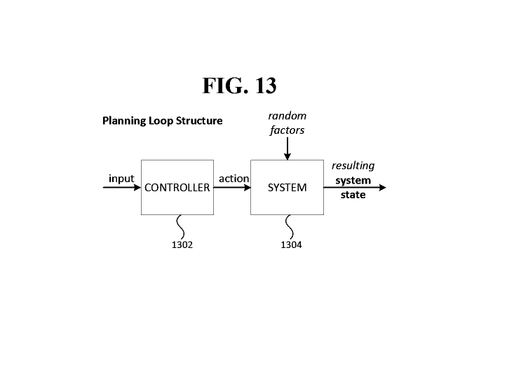

FIG. 13 is a schematic diagram illustrating the planning loop structure. The diagram is a representation of an iterative process that refines results in a loop. Input goes through a controller 1302, which processes the information to output an action, where such action then is influenced and corrected by external non-related factors that the system 1304 adjusts and fine tunes to output a resulting system state. The resulting system state then may become the input into the controller once again and go through the iterative process of refinement once again to end up in an even more refined and enhanced resulting system state that becomes an ever more accurate representation relative to the previous resulting system state. This is precisely what planning loop structures refer to as described herein. The iterative process of self-correction so as to improve the resulting system state uses past experiences, correlations, clusters, and other relevant data including random factors depending on the process. This is a form of machine learning.

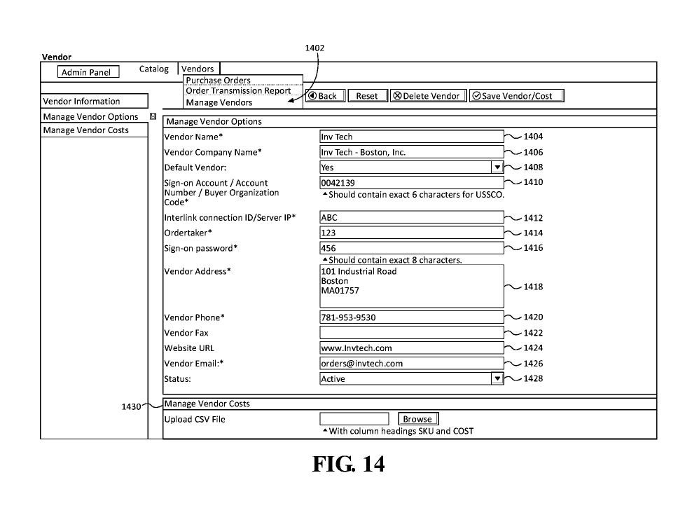

Referring to FIG. 14 is a screen display of the vendor information management page as input by a company in an example implementation of the product listing & procurement system shown in FIG. 12, where vendor company details can be entered and products for listing can be uploaded to the system. Such products uploaded become available for electronic commerce transactions within the private marketplace of the listing and procurement system. Uploading product details via the admin panel in the example updates the products and details displayed on the front-end for visibility to the users via the internet in a web-based implementation.

The company listing products or services enters the system via the screen manage vendors 1402. Then they enter the company name 1404 and other details pertaining to the vendor order transmission such as sign-on-account number 1410 and other details. Once completed, they can enter the vendor costs via an upload 1430. The entrepreneur companies also have access to upload product details with images for display on the front-end catalog viewable by other users of the system.

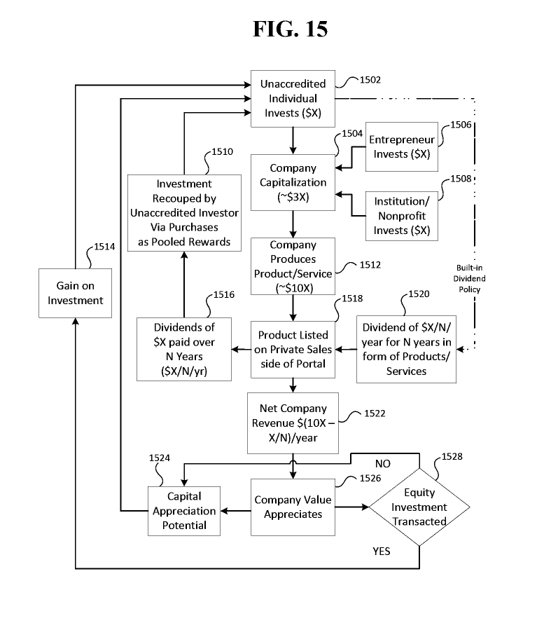

FIG. 15 is a flowchart diagram depicting a method of paying dividend to unaccredited individual crowd fund investors. When a certain amount is invested by unaccredited crowd investors 1502 and matched by the entrepreneur 1506 and institutions 1508, the company capitalization 1504 goes to three times or more of the amount invested by the unaccredited crowd investors (for example), thus leading to an investment multiple of 3 to 4 and a multiple of another 3 to 4 in terms of production output 1512 with the output working out to over 10 times the unaccredited crowd investor investment amount.

Dividend payments on equity investments to investors are typically in the form of cash. In an exemplary embodiment, however, the dividend paid is in a non-cash form, such as rewards, reward points, credits or allowances 1520 that can later be used by the recipient in the listing and procurement system/portal of the crowd funding private equity investment processing system 100.

For example, the price to sales (P/S) ratio of public stocks averaged across many companies (e.g., 10,000 companies) based on data over 5 years found a value of the order of 1. The price to earnings ratio (P/E) across the aggregate data is 20 when rounded off to the nearest 5. When these ratios are extrapolated for private companies which normally trade at multiples of 6-7 times EBIDTA, it can be deduced that private companies have the potential to produce at least $3 of sale for every $1 of investment. As the crowd funding private equity investment processing system aligns product/service benefit and consumption, it would be advantageous to provide all unaccredited individual crowd investors with a discount on the products produced by the companies they help fund because basic economics suggests that lower price would increase quantity or demand, and that would be beneficial for the companies. Illustrative embodiments thus may provide a non-cash dividend to all unaccredited individual crowd investors, which would be equivalent to reward points or credits or rebates/allowances to be utilized on the on the product listing and procurement portal of the system which would help them receive the intended discounts. Given that the average holding of the group comprising unaccredited individual crowd investors in companies in the system may be of the order of 33%, for example, it can be assumed that for every dollar invested by an individual, the net sales revenue that it will translate into for the company producing output will be of the order of $10 based on the fact that the each dollar invested by an unaccredited individual is usually backed by another two dollars of investment and each dollar of investment will produce three dollars or more of sales revenue at steady state on average.

Continuing with this example, illustrative embodiments provide the $1 invested by unaccredited individual crowd investors 1502 back to them in the form of dividend 1510 at the rate of about 33% annually for the first 3 years, thereby effectively allowing them to recoup their investment in a non-cash form. This would have the effect of driving demand for products and services while have the net effect of lowering the sales revenue only to the extent of $0.33 for every $10 of sales or output, which is a small price to drive demand. In fact, this methodology would not only drive demand for products produced by the companies, but as the unaccredited individual crowd investors would also have the potential of appreciation of their investment, it would also drive demand for the sale of equity investment instruments if such dividends were part of the deal. The method of paying a dividend to unaccredited individual crowd investors on their investment in a form other than cash, such as rewards, credits and allowances that can be utilized towards purchases of products from the product listing and procurement portal of the system, is an embodiment of the present invention.

Pooled rewards may also be created in exchange for specific investments so that unaccredited individual crowd investors can use their pooled rewards from a pool of output producers or several companies that have products and services to offer via the product listing and procurement portal rather than only from the specific company in which they invested.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

Exemplary unique features of the processing system and method of the invention include the following:

A private equity investment processing system for unaccredited investors that includes subscription, payment, and allotment of private equity shares, options, convertible debentures or any other financial derivative of private equity,

A system that combines unaccredited investors with strategic institutional and nonprofit investors for simultaneous participation,

A system that automates the investment decision-making process and recommends matches between crowd investors and companies with higher probability of venture success for private equity investment,

A system that enables computer aided processing of the complete investment lifecycle of private equity instruments from subscriptions to allotments with payment processing,

A system that connects to a product listing and procurement portal to enable companies to launch their products to the community of users of the system for sale at preferential pricing in the virtual private marketplace,

A system that utilizes an interactive visual survey generator to capture inputs from companies,

A system that enables strategic institutional investors to make an offer to purchase chunks of the unaccredited individual crowd investor holding and where such unaccredited individual crowd investors can accept offers to resell their equity holding automatically,

A system where rewards, credits and allowances are automatically credited to the account of unaccredited individual crowd investors as dividend, and where such dividend can be used towards purchase of any product(s) offered for private sale by companies on the product listing and procurement portal of the system,

A method of crowd funding that combines multiple investor groups including unaccredited investors with entrepreneurs simultaneously,

A method of crowd funding that automates investment decision-making and recommends companies to investors,

A method of crowd funding that automates the closing process of subscriptions for multiple rounds of funding with payment processing,

A method of crowd funding with a built-in second round after a pre-determined period of time based on a trigger of milestone achievement that investors can vote on,

A method of collecting, analyzing and processing company, venture and project attributes using an interactive visual survey generator which does not require the need to fill in any forms to provide input,

A method of listing of products for private sale by a company in the role of vendor to offer preferential reduced pricing to a private marketplace of all investors and all companies using the system of the invention to increase demand,

A method of converting a ‘business plan’ of a company seeking funding with a viable venture or project into a ‘capitalization table’ based on system induced ‘due diligence’ that is finally broken down into (a) an ‘equity instrument such as equity shares, options or convertible debentures’, (b) a ‘price’, and (c) ‘quantity or number of equity instruments’, and then offering such equity instruments to unaccredited individual crowd investors for sale, automatically managing the subscription, payment and allotment process through to the steps of shareholding, dividend distribution and voting rights of such shareholders and the option for unaccredited individual crowd investors to list their holdings for resale to others, facilitating the entire transaction,

A method where strategic institutional investors have the ability to make an offer to purchase chunks of the unaccredited individual crowd investor holding and where such unaccredited individual crowd investors can accept offers to resell their equity holding automatically,

A method where an unaccredited individual crowd investor is offered dividend on their investment in forms other than cash comprising rewards, credits and allowances and where such dividend can be used towards purchase of any product(s) offered for private sale by companies on the product listing and procurement portal of the system,

A computer program implementing the method and sub-methods of the system,

A web-based implementation of the method and sub-methods of the system, and/or

An implementation of the system using the method via a network of mobile devices or on social networks.

In various embodiments, the crowd funding private equity investment processing system comprises:

An input device that collects crowd information with specific attributes,

An interactive visual survey generator that generates responses interactively from entrepreneurs relating to company, venture and project specific attributes,

A valuation processor that processes responses from the interactive visual survey generator,

A profile assimilator that acquires and organizes information from strategic institutional/nonprofit investors with specific attributes,

An investment processor that processes information from the profile assimilator, and/or

A solution generator that processes input from the valuation processor and the investment processor, dynamically processing linkages between the information and meta information to form clusters of elemental information and make appropriate computations, associations and new linkages.

Exemplary embodiments of the method used with the processing system include any of the following steps:

Inputting unaccredited individual crowd investor information with specific attributes such as role, expertise, interest in product/service, and amount available for investment commitment via a visual survey generator,

Organizing the crowd fund information and creating meta information based on attributes of such information to form clusters of elemental information that allow it to be mapped to select clusters of other information based on planning loop structures,

Using an interactive visual survey generator to generate responses for specific company, venture or project attributes that include product/service domain, social benefit, economic feasibility, technology and management expertise,

Processing the responses from the interactive visual survey generator via a valuation processor that combines it with financial and market information from the business plan and external data using a multi-dimensional second order polynomial mathematical equation to determine values for probability of venture success, intellectual property advantage and social good effect,

Assimilating strategic institutional/nonprofit investor information in a profile assimilator based on specific attributes such as focus area, product/service domain, consumption volume, resources, and timeline,

Processing the information from the profile assimilator via an investment processor and assigning meta-information to the institution/nonprofit based on attributes using a multi-dimensional second order polynomial mathematical equation to determine values for risk tolerance, alignment of product/service, and benefit evaluation,

Processing the results of the valuation processor and the investment processor in a solution generator to form clusters of information using econometrics and coefficient of determination to determine cluster relationships, and/or

Recommending clusters that have highest coefficient of determination of the indices computed to automate closing of the investment cycle for unaccredited individual crowd investors and institutional/nonprofit investors simultaneously through multiple rounds of funding using planning loop structures.

Further exemplary features of the invention include:

1. A processing system comprising:
i. An input device that collects crowd information with specific attributes,
ii. An interactive visual survey generator that generates responses interactively from entrepreneurs relating to company, venture and project specific attributes,
iii. A valuation processor that processes responses from the interactive visual survey generator,
iv. A profile assimilator that acquires and organizes information from strategic institutional/nonprofit investors with specific attributes,
v. An investment processor that processes information from the profile assimilator, and/or
vi. A solution generator that processes input from the valuation processor and the investment processor, dynamically processing linkages between the information and meta information to form clusters of elemental information and make appropriate computations, associations and new linkages.

2. The processing system of point 1 wherein project specific attributes include information and meta-information on product/service domain, social benefit, economic feasibility, technology and management expertise.

3. The processing system of point 1 wherein specific attributes from a strategic institutional or nonprofit group include information and meta-information on focus area, product/service domain, consumption volume and resources.

4. The processing system of point 1 wherein computations, associations and new linkages are made based on the elemental information and attributes input into the system, such associations and new linkages being determined on the basis of coefficient of determination measures derived from econometric computational analysis of the attribute and other data.

5. The processing system of point 1 wherein responses are processed from the interactive visual survey generator.

6. The processing system of point 1 wherein planning loop structures are used for making computations and wherein each planning loop structure includes the steps of providing an input to a controller that outputs an action, inputting that action into the system, adding random factors to the system, and measuring the resulting system state.

7. The processing system of point 1 wherein the system is connected to at least one of a knowledge repository, an enterprise data storage, a market information database, or a computer device capable of receiving input from a domain analyst.

8. The processing system of point 1 wherein the solution generator comprises a recommendation engine capable of receiving and executing a set of business rules to process the information of the system and provide an output back to the computer devices of various users with the processed results.

9. The processing system of point 1 wherein multiple users are interconnected to the processing system simultaneously and from three distinctive groups of users, the first group comprising any number of unaccredited individuals from the crowd who are prospective investors, the second group comprising entrepreneurs with companies, ventures or projects seeking funding for their companies via a sale of private equity shares, options, convertible debentures or any other financial derivative of private equity, and the third group comprising strategic institutional and nonprofit investors who wish to participate in investing alongside the crowd.

10. The processing system of point 1 wherein the linkages are dynamically processed by the solution generator and rely on multi-dimensional second order polynomial mathematical equation and a coefficient of determination, or a combination of these two in order to process such linkages.

11. The processing system of point 1 wherein the dependencies and linkages as processed by any one or more of a valuation processor, investment processor, and solution generator, depend on factors that are computed based on the functionality of risk tolerance, alignment of product/service, benefit evaluation, probability of venture success, intellectual property advantage and social good index that are used to form clusters derived from elemental attributes, information and meta-information comprising at least one of focus area, product/service domain, consumption volume, resources, social benefit, economic feasibility, technology, management expertise and timeline.

12. The processing system of point 1 wherein connectivity to other systems and the various links are secure and web-based, including web-based links utilizing extensible markup language, active server programming languages, and connective technology languages, which assign descriptors and tags to data types and/or aid in the interfacing of hardware and software, and the processing is done online, in real time, and across the enterprise.

13. The processing system of point 1 wherein the system is interconnected to at least one of a software robot application, a collaborative system, an electronic messaging or email system, an accounting system, an enterprise application integrator, an online portal, a web-based mashup, an online social network, and a wireless mobile device such as a smartphone or tablet.

14. The processing system of point 1 executing a computer based method delivering increased alignment of product/service benefits, improved probability of venture success and reduced risk when matching unaccredited individual crowd investors with companies, ventures and projects to invest in, the method including the steps of:

Inputting unaccredited individual crowd investor information with specific attributes such as role, expertise, interest in product/service, and amount available for investment commitment via a visual survey generator,

Organizing the crowd fund information and creating meta information based on attributes of such information to form clusters of elemental information that allow it to be mapped to select clusters of other information based on planning loop structures,

Using an interactive visual survey generator to generate responses for specific company, venture or project attributes that include product/service domain, social benefit, economic feasibility, technology and management expertise,

Processing the responses from the interactive visual survey generator via a valuation processor that combines it with financial and market information from the business plan and external data using a multi-dimensional second order polynomial mathematical equation to determine values for probability of venture success, intellectual property advantage and social good effect,

Assimilating strategic institutional/nonprofit investor information in a profile assimilator based on specific attributes such as focus area, product/service domain, consumption volume, resources, and timeline,

Processing the information from the profile assimilator via an investment processor and assigning meta-information to the institution/nonprofit based on attributes using a multi-dimensional second order polynomial mathematical equation to determine values for risk tolerance, alignment of product/service, and benefit evaluation,

Processing the results of the valuation processor and the investment processor in a solution generator to form clusters of information using econometrics and coefficient of determination to determine cluster relationships, and/or

Recommending clusters that have highest coefficient of determination of the indices computed to automate closing of the investment cycle for unaccredited individual crowd investors and institutional/nonprofit investors simultaneously through multiple rounds of funding using planning loop structures.

15. The processing system of point 14 that is used to allocate shares, options, convertible debentures or any other financial derivative of private equity to crowd individuals.

16. The processing system of point 14 that is connected to a product listing and procurement system serving as a private marketplace portal.

17. A computer based method to match unaccredited individual crowd investors, strategic institutional/nonprofit investors, and entrepreneurs to deliver increased alignment of product/service benefits and consumption, improved probability of venture success, reduced overall financial risk, and greater efficiency of crowd capital deployment, the method including the steps of:

Inputting unaccredited individual crowd investor information with specific attributes such as role, expertise, interest in product/service, and amount available for investment commitment via an input device or survey generator,

Organizing the crowd fund information and creating meta information based on attributes of such information to form clusters of elemental information that allow it to be mapped to select clusters of other information based on planning loop structures,

Using an interactive visual survey generator to generate responses for specific company, venture or project attributes that include product/service domain, social benefit, economic feasibility, technology and management expertise,

Processing the responses from the interactive visual survey generator via a valuation processor that combines it with financial and market information from the business plan and external data using a multi-dimensional second order polynomial mathematical equation to determine values for probability of venture success, intellectual property advantage and social good effect,

Assimilating strategic institutional/nonprofit investor information in a profile assimilator based on specific attributes such as focus area, product/service domain, consumption volume, resources, and timeline,

Processing the information from the profile assimilator via an investment processor and assigning meta-information to the institution/nonprofit based on attributes using a multi-dimensional second order polynomial mathematical equation to determine values for risk tolerance, alignment of product/service, and benefit evaluation,

Processing the results of the valuation processor and the investment processor in a solution generator to form clusters of information using econometrics and coefficient of determination to determine cluster relationships, and/or

Recommending clusters that have highest coefficient of determination of the indices so computed to automate matching and closing of the investment cycle for unaccredited individual crowd investors and institutional/nonprofit investors simultaneously with companies in multiple rounds of funding using planning loop structures.

18. The computer based method of point 17 wherein the information used for processing is from one or more of a knowledge repository, enterprise data storage, accounting system, or market information database.

19. The computer based method of point 17 wherein the information about entrepreneurs, their companies, ventures and projects, includes attributes of market growth rates, predicted global demand trends, and committed future consumption patterns of different investor groups.

20. The computer based method of point 17 wherein the planning loop structures include history of prior matches, the evolution pattern of companies with data related to the rate of change of attribute values and valuations and their respective trends over time.

21. The computer based method of point 17 that is used to allocate shares, options, convertible debentures or any other financial derivative of private equity to crowd individuals.

22. The computer based method of point 17 wherein the matches are communicated within a social network automatically via an online social network, the online social network referring to an individual's set of direct and/or indirect personal relationships.

23. The computer based method of point 17 wherein the information used is for determining processing multiple rounds of funding to accommodate funding at different stages of the investment lifecycle of a company.

24. The computer based method of point 17 wherein the process of matching unaccredited individual crowd investors with companies, ventures and projects includes the steps of:

identifying a plurality of frames including a plurality of planning loop structures, each planning loop structure including a first set of objects,

linking objects within the first set of objects to each other,

assigning a set of attributes to each of the first set of objects within the planning loop structures with dynamic states,

assigning a mathematical formula to each of the first set of objects, the planning loop structures thus linked, with attributes and dynamic states, yielding an expanded loop structure, and

connecting the plurality of planning loop structures and the expanded loop structure to at least one of a valuation processor, investment processor, solution generator, and match processor.

25. The computer based method of point 24 wherein the first set of objects includes elements that each represent product/service domain, social benefit, economic feasibility, technology, management expertise, focus area, consumption volume, resources and timeline to generate a second set of objects that includes values for probability of venture success, intellectual property advantage, social good index, risk tolerance, alignment of product/service, and benefit evaluation.

26. A machine readable medium tangibly embodying a program of non-transitory, machine-readable instructions executable by a digital processing apparatus to complete data transformation steps comprising:

Inputting unaccredited individual crowd investor information with specific attributes such as role, expertise, interest in product/service, and amount available for investment commitment via an input device or survey generator,

Organizing the crowd fund information and creating meta information based on attributes of such information to form clusters of elemental information that allow it to be mapped to select clusters of other information based on planning loop structures,

Using an interactive visual survey generator to generate responses for specific company, venture or project attributes that include product/service domain, social benefit, economic feasibility, technology and management expertise,

Processing the responses from the interactive visual survey generator via a valuation processor that combines it with financial and market information from the business plan and external data using a multi-dimensional second order polynomial mathematical equation to determine values for probability of venture success, intellectual property advantage and social good effect,

Assimilating strategic institutional/nonprofit investor information in a profile assimilator based on specific attributes such as focus area, product/service domain, consumption volume, resources, and timeline,

Processing the information from the profile assimilator via an investment processor and assigning meta-information to the institution/nonprofit based on attributes using a multi-dimensional second order polynomial mathematical equation to determine values for risk tolerance, alignment of product/service, and benefit evaluation,

Processing the results of the valuation processor and the investment processor in a solution generator to form clusters of information using econometrics and coefficient of determination to determine cluster relationships, and/or

Recommending clusters that have highest coefficient of determination of the indices so computed to automate matching and closing of the investment cycle for unaccredited individual crowd investors and institutional/nonprofit investors simultaneously with companies in multiple rounds of funding using planning loop structures.

27. The machine readable medium of point 26 wherein the results are stored in a multimedia data warehouse for the creation of an improved knowledge base, the improved knowledge base being connectable to the processing system, including connections made by wireless remote connectivity and via the internet for mass storage and retrieval of processed information.

28. A non-transitory computer program product tangibly embodied on a computer readable medium and comprising a program code for directing at least one computer to receive input data and follow one or more data transformation steps of point 26.

29. The computer program product of point 28 wherein the output is used for processing of private equity investment steps comprising:

Allocating shares, options, convertible debentures or any other financial derivative of private equity to crowd individuals in an automated manner for one or more rounds of funding while adjusting for any over-subscriptions and under-subscriptions,

Providing information on shares, options, convertible debentures or any other financial derivative of private equity allocated for each investment round back to the crowd individual shareholders and updating information on their total cumulative holding and voting rights,

Enabling the crowd individual shareholders to communicate with the company and vote in company related matters based on their voting rights and keeping track of such votes, and/or

Allowing crowd individual shareholders to list their shareholding for resale to the company founders or other shareholders after any waivers.

30. The computer program product of point 28 wherein unaccredited individual crowd investors are allocated dividends in non-cash form equivalent to rewards, credits or allowances to be used for purchase of products via an interconnected private marketplace portal.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method of operating an equity crowd funding system with different types of investors, the method comprising:
registering a company with an equity crowd funding system;
registering a first investor with the equity crowd funding system;
registering a second investor with the equity crowd funding system, wherein each of the first and second investors is an unaccredited investor, an accredited investor, an institutional investor, a non-profit investor, or an entrepreneur, and the first and second investors are different types of investors; and
sending to the first and second investors offers for equity holdings in the company in exchange for funds.

2. The method of claim 1, wherein sending the offers for equity holdings comprises:
sending offers for equity shares, options, convertible debentures, or other financial derivatives in the company.

3. The method of claim 1, further comprising:
receiving a first payment from the first investor, wherein the first payment constitutes acceptance of the offer and the first investor is an institutional investor; and
receiving a second payment from the second investor, wherein the second payment constitutes acceptance of the offer and the second investor is an unaccredited investor or an accredited investor.

4. The method of claim 3, further comprising:
sending to the second investor an offer from the first investor to purchase equity holdings in the company owned by the second investor.

5. The method of claim 4, further comprising:
receiving, from the second investor, an automatic acceptance of the offer for the equity holdings in the company owned by the second investor.

6. A computer program product including a non-transitory computer-readable medium having computer code thereon for operating an equity crowd funding system with different types of investors, the computer code comprising:
program code for registering a company with an equity crowd funding system;
program code for registering a first investor with the equity crowd funding system;
program code for registering a second investor with the equity crowd funding system, wherein each of the first and second investors is an unaccredited investor, an accredited investor, an institutional investor, a non-profit investor, or an entrepreneur, and the first and second investors are different types of investors; and
program code for sending to the first and second investors offers for equity holdings in the company in exchange for funds.

7. The computer program product of claim 6, wherein the program code for sending the offers for equity holdings comprises:
program code for sending offers for equity shares, options, convertible debentures, or other financial derivatives in the company.

8. The computer program product of claim 6, further comprising:
program code for receiving a first payment from the first investor, wherein the first payment constitutes acceptance of the offer and the first investor is an institutional investor; and
program code for receiving a second payment from the second investor, wherein the second payment constitutes acceptance of the offer and the second investor is an unaccredited investor or an accredited investor.

9. The computer program product of claim 8, further comprising:
program code for sending to the second investor an offer from the first investor to purchase equity holdings in the company owned by the second investor.

10. The computer program product of claim 9, further comprising:
program code for receiving, from the second investor, an automatic acceptance of the offer for the equity holdings in the company owned by the second investor.

11. An apparatus comprising:
at least one processor and at least one memory encoded with instructions, wherein execution of the instructions by the at least one processor causes the at least one processor to:
register a company with an equity crowd funding system;
register a first investor with the equity crowd funding system;
register a second investor with the equity crowd funding system, wherein each of the first and second investors is an unaccredited investor, an accredited investor, an institutional investor, a non-profit investor, or an entrepreneur, and the first and second investors are different types of investors; and
send to the first and second investors offers for equity holdings in the company in exchange for funds.

12. The apparatus of claim 11, wherein the at least one memory further includes instructions whose execution by the at least one processor causes the at least one processor to:
send offers for equity shares, options, convertible debentures, or other financial derivatives in the company.

13. The apparatus of claim 11, wherein the at least one memory further includes instructions whose execution by the at least one processor causes the at least one processor to:
receive a first payment from the first investor, wherein the first payment constitutes acceptance of the offer and the first investor is an institutional investor; and
receive a second payment from the second investor, wherein the second payment constitutes acceptance of the offer and the second investor is an unaccredited investor or an accredited investor.

14. The apparatus of claim 13, wherein the at least one memory further includes instructions whose execution by the at least one processor causes the at least one processor to:
send to the second investor an offer from the first investor to purchase equity holdings in the company owned by the second investor.

15. The apparatus of claim 14, wherein the at least one memory further includes instructions whose execution by the at least one processor causes the at least one processor to:
receive, from the second investor, an automatic acceptance of the offer for the equity holdings in the company owned by the second investor.
